(19) United States
(12) Patent Application Publication
(10) Pub. No.: US 2006/0152899 A1
(43) Pub. Date: Jul. 13, 2006

(54) External data storage device with decorative illuminating effect

(75) Inventor: Chia-Jen Wang, Taipei Hsien (TW)

Correspondence Address: Ladas & Parry, Suite 2100, 5670 Wilshire Boulevard, Los Angeles, CA, 90036-5679, US

(73) Assignee: DATASTOR TECHNOLOGY CO., LTD.

(21) Appl. No.: 11/134,652

(22) Filed: May 20, 2005

(30) Foreign Application Priority Data
Jan. 7, 2005 (TW) 094200355

(51) Int. Cl. G06F 1/16

(52) U.S. Cl. 361/685; 361/683

(57) ABSTRACT

An external data storage device includes a housing unit having a control board with a coupler that is adapted for establishing electrical coupling with a computer device, and a power-managing module capable of being activated regardless of whether there is coupling between the external data storage device and the computer device. A data storage unit is mounted in the housing unit, and is electrically coupled to the control board. A light-generating assembly is mounted on the housing unit, and is electrically coupled to and controlled by the control board of the housing unit. The light-generating assembly provides decorative illumination regardless of whether there is coupling between the external data storage device and the computer device, and status indication for indicating an operating state of the data storage unit when there is such coupling.

### CROSS-REFERENCE TO RELATED APPLICATION

This application claims priority of Taiwanese Application No. 094200355, filed on Jan. 7, 2005.

### BACKGROUND OF THE INVENTION

1. Field of the Invention

The present invention relates to an external data storage device, more particularly to an external data storage device with a decorative illuminating effect.

2. Description of the Related Art

The development of external bus standards, such as USB (Universal Serial Bus) 2.0 and IEEE (Institute of Electrical and Electronic Engineers) 1394, have helped popularize plug-and-play external data storage devices. External data storage devices are electrically coupled to a computer, and are used to provide backup and even a full working copy of the internal computer hard drive.

Referring to FIG. 1, a conventional external data storage device 1 is shown to include two light indicators 11, 12. As an example, the light indicator 11 indicates On and Off states of the external data storage device 1, while the light indicator 12 is activated during read and write operations of the external storage device 1.

A drawback of such a lighting scheme is that the light indicators 11, 12 are purely utilitarian, providing only indication as described above, and are not designed to enhance aesthetic appeal. Furthermore, since the light indicators 11, 12 are supplied with power from the computer, operation of the light indicators 11, 12 is possible only when there is coupling between the external data storage device 1 and the computer.

### SUMMARY OF THE INVENTION

The object of this invention is to provide an external data storage device having a decorative illuminating effect, in which illumination is performed to indicate operating states of the external data storage device, as well as to enhance the appearance of the external data storage device.

The external data storage device of this invention comprises: a housing unit including a control board having a coupler that is adapted for establishing electrical coupling with a computer device, and a power-managing module that is capable of being activated regardless of whether there is coupling between the external data storage device and the computer device; a data storage unit mounted in the housing unit, and electrically coupled to the control board; and a light-generating assembly mounted on the housing unit, and electrically coupled to and controlled by the control board of the housing unit. The light-generating assembly is operable to provide a decorative illuminating effect regardless of whether there is coupling between the external data storage device and the computer device. The light-generating assembly is further operable to provide a status indicating effect for indicating an operating state of the data storage unit when there is coupling between the external data storage device and the computer device.

### BRIEF DESCRIPTION OF THE DRAWINGS

Other features and advantages of the present invention will become apparent in the following detailed description of the preferred embodiments with reference to the accompanying drawings, of which:

FIG. 1 is a perspective view of a conventional external data storage device;

FIG. 2 is a perspective view of an external data storage device according to a first preferred embodiment of the present invention, illustrating the external data storage device electrically coupled to a computer device;

FIG. 3 is an exploded perspective view of the external data storage device of FIG. 2;

FIG. 4 is an exploded perspective view of a first housing of FIG. 3, illustrating elements mounted in and on the first housing;

FIG. 5 is a perspective view of an illuminating light-guiding plate of FIG. 4;

FIG. 6 is a sectional view taken along line VI-VI of FIG. 5, illustrating the passage of light emitted by two light-emitting elements through the illuminating light-guiding plate;

FIG. 7 is a perspective view of an indicator light-guiding plate of FIG. 4;

FIG. 8 is a sectional view taken along line VIII-VIII of FIG. 7, illustrating the passage of light emitted by an operating-state indicator through the indicator light-guiding plate;

FIG. 9 is a schematic circuit block diagram of a control board of FIG. 4, and elements electrically coupled thereto;

FIG. 10 is a perspective view of an external data storage device according to a second preferred embodiment of the present invention; and

FIG. 11 is a sectional view taken along line XI-XI of FIG. 10.

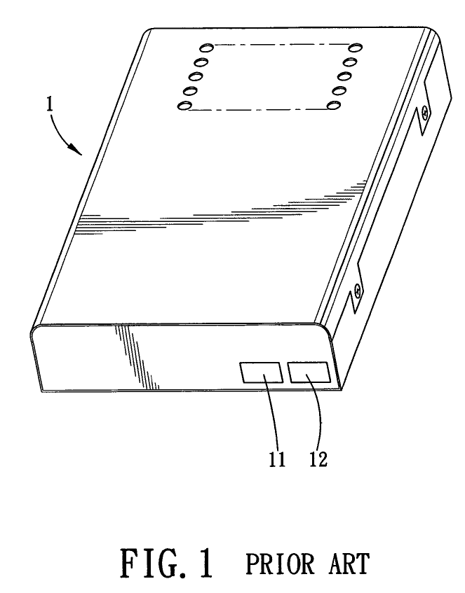

### DETAILED DESCRIPTION OF THE PREFERRED EMBODIMENTS

Before the present invention is described in greater detail, it should be noted that like elements are denoted by the same reference numerals throughout the disclosure.

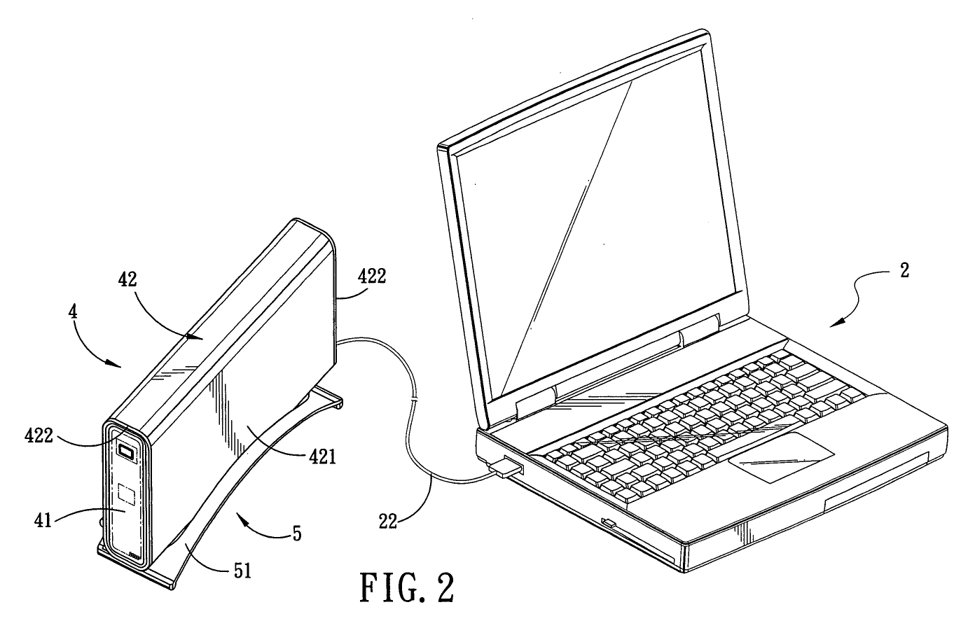

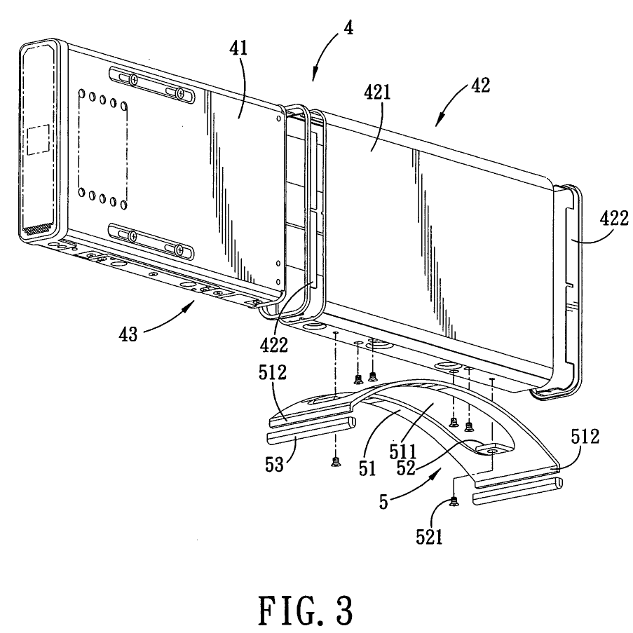

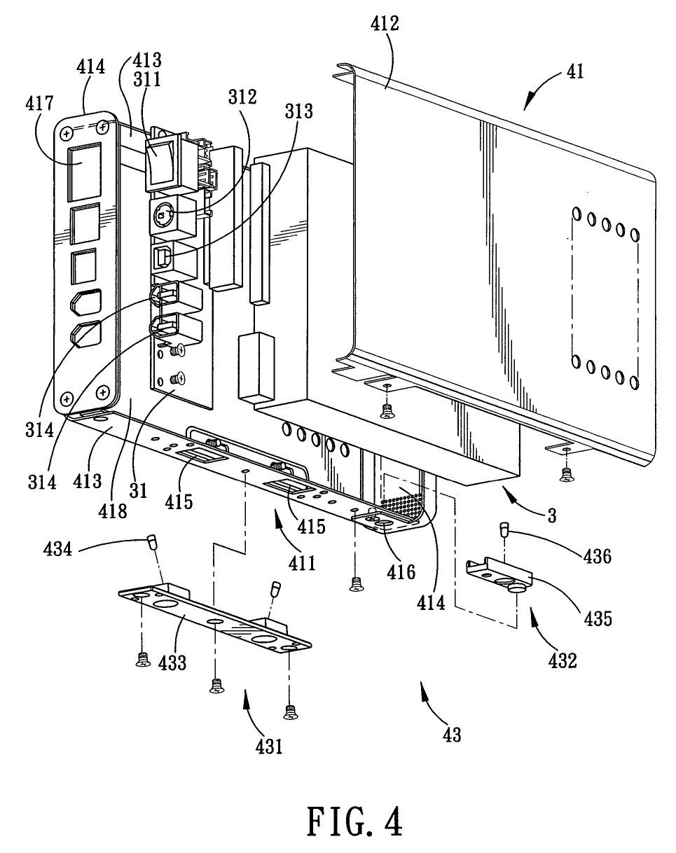

FIG. 2 shows an external data storage device with a decorative illuminating effect according to a first preferred embodiment of the present invention. The external data storage device is electrically coupled to a computer device 2 via a data transmission line 22. The computer device 2 may be a personal computer or a laptop computer. With additional reference to FIGS. 3 and 4, the external data storage device includes a housing unit 4, a data storage unit 3 mounted in the housing unit 4, and a base 5 for supporting the housing unit 4 on a support surface (not shown), such as a working surface of a desk.

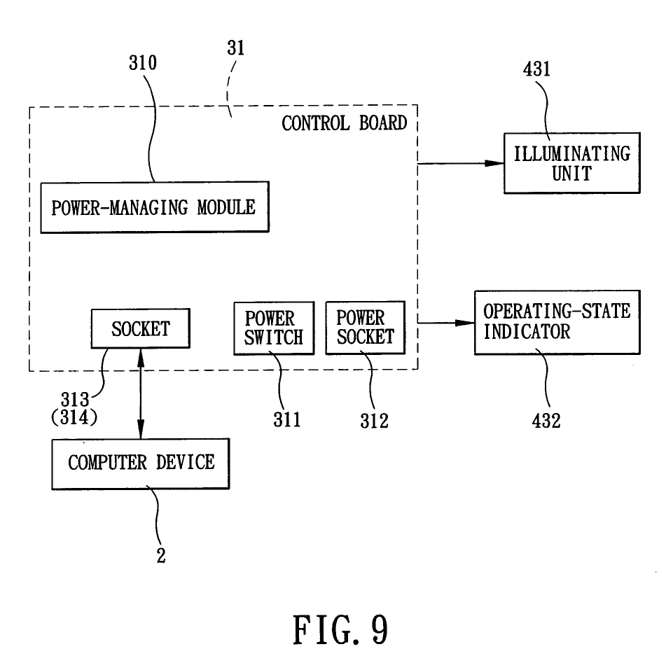

The housing unit 4 includes a first housing 41 in which the data storage unit 3 is mounted, and a second housing 42 into which the first housing 41 is inserted. A control board 31 is mounted in the first housing 41 of the housing unit 4. With reference also to FIG. 9, a power switch 311, and a plurality of sockets 312-314 are mounted on and are electrically coupled to the control board 31. The control board 31 includes a power-managing module 310 that is capable of being activated by user operation of the power switch 311 regardless of whether there is coupling between the external data storage device and the computer device 2. In the first preferred embodiment, the socket 312 is used for electrical coupling to an AC (alternating current) power outlet (not shown), the socket 313 is a USB socket, and the sockets 314 are IEEE 1394 sockets. Any one of the sockets 313, 314 may be used as a coupler for electrical coupling with the computer device 2, as well as with other USB- and IEEE 1394-based peripheral devices. Alternatively, the external data storage device and the computer device 2 may be wirelessly connected using known techniques.

The data storage unit 3 is electrically coupled to the control board 31. The data storage unit 3 may be a hard-disk drive (HDD), a magnetic disk drive, an optical storage device, flash memory, or any other type of device capable of storing data.

The first housing 41 of the housing unit 4 includes a first cover 411, and a second cover 412 connected to the first cover 411. The first cover 411 includes a planar plate 418 having upper and lower horizontal edges, and left and right vertical edges, a pair of upper and lower horizontal skirt plates 413 respectively extended rightwardly from the upper and lower horizontal edges of the planar plate 418, and a pair of left and right vertical skirt plates 414 respectively extended rightwardly from the left and right vertical edges of the planar plate 418. The lower horizontal skirt plate 413 includes two first apertures 415, and a second aperture 416. The left vertical skirt plate 414 includes five through holes 417 for allowing passage respectively of the power switch 311, the power socket 312, the USB socket 313, and the two IEEE 1394 sockets 314.

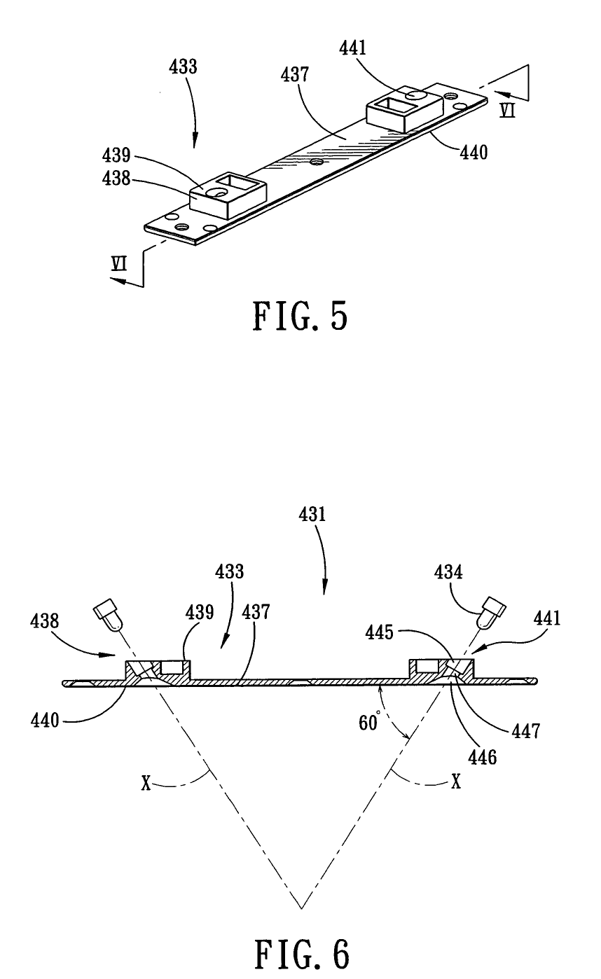

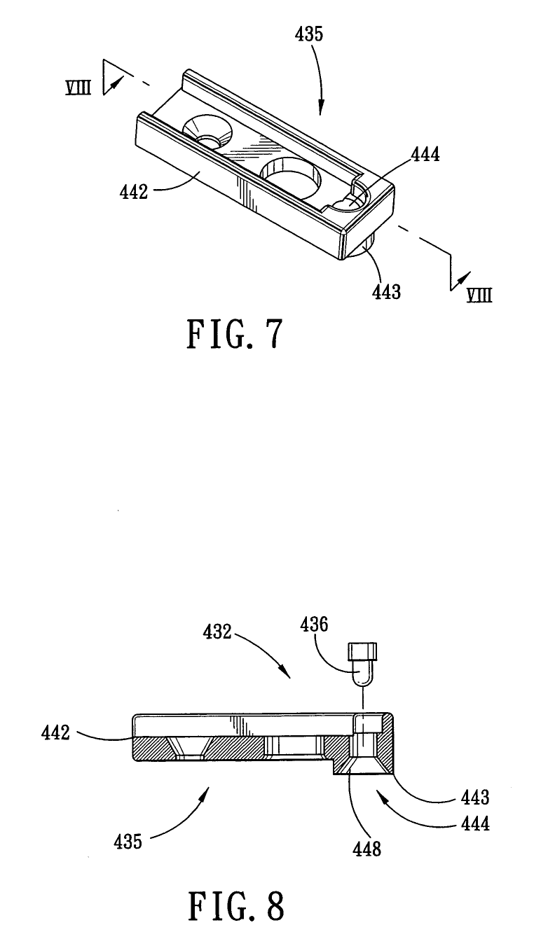

In this embodiment, a light-generating assembly 43 is mounted to a lower end of the first housing 41. The light-generating assembly 43 is electrically coupled to and controlled by the control board 31 of the data storage unit 3, and includes an illuminating unit 431, and an operating-state indicator 432. With further reference to FIGS. 5 and 6, the illuminating unit 431 includes an illuminating light-guiding plate 433 mounted on the lower horizontal skirt plate 413 of the first housing 41, and two light-emitting elements 434 mounted above the illuminating light-guiding plate 433. With further reference to FIGS. 7 and 8, the operating-state indicator 432 includes an indicator light-guiding plate 435 mounted on the lower horizontal skirt plate 413, and a state indicating element 436 mounted above the indicator light-guiding plate 435. In the first preferred embodiment, the light-guiding plates 433, 435 are transparent.

The second housing 42 includes a casing 421 into which the first housing 41 is inserted, and lids 422 mounted to opposite ends of the casing 421.

The base 5 is used to support the housing unit 4. In the first embodiment, the base 5 includes a downwardly curved arc-shaped stand 51 defining a slot 511 in a center portion thereof, and having two support ends 512 contacting the support surface to support the housing unit 4 thereon. Two transparent plastic sleeves 53 are sleeved respectively on the support ends 512 of the stand 51. A load-bearing tab 52 is formed on opposite end areas of the stand 51 extending into the slot 511. The load-bearing tabs 52 are fixed to the housing unit 4 through screws 521.

In the first preferred embodiment, the light-emitting elements 434 and the state-indicating element 436 are light-emitting diodes (LEDs). When the power switch 311 of the control board 31 is controlled to the On position, the light-emitting elements 434 of the illuminating unit 431 are activated to emit light to thereby perform an illuminating function. With the provision of the power-managing module 310 in the housing unit 4, such control is possible regardless of whether the external data storage device is coupled to the computer device 2. Further, in a state where the external data storage device is electrically coupled to the computer device 2, the state-indicating element 436 of the operating-state indicator 432 is driven to emit light during read and write operations of the data storage unit 3 in a conventional manner.

The illuminating unit 431 and the operating-state indicator 432 will now be described in greater detail. First, with reference to FIGS. 5 and 6, the illuminating light-guiding plate 433 of the illuminating unit 431 includes a first plate member 437, a pair of first protruding members 438 protruded upwardly from the first plate member 437, and a pair of illuminating light-passage holes 441 that pass through the illuminating light-guiding plate 433 at a predetermined angle to the first plate member 437 starting from upper surfaces 439 of the first protruding members 438 to a lower surface 440 of the first plate member 437. Each of the illuminating light-passage holes 441 includes a large diameter section 445 adjacent to the upper surface 439 of the corresponding first protruding member 438, a first irradiating aperture 446 adjacent to the lower surface 440 of the first plate member 437, and a small diameter section 447 interposed between the large diameter section 445 and the first irradiating aperture 446. The small diameter sections 447 have a smaller diameter than the large diameter sections 445.

Imaginary straight lines (X) are respectively passed through centers of the illuminating light-passage holes 441. In the first preferred embodiment, each of the imaginary straight lines (X) forms an angle of approximately 60° with the lower surface 440 of the first plate member 437. The angle of each of the imaginary lines (X) with the first plate member 437 is such that the light projected through the illuminating light-passage holes 441 intersects on the support surface after passing through the base 5. This further enhances the decorative effect provided by the illuminating unit 431.

With reference to FIGS. 7 and 8, the indicator light-guiding plate 435 of the operating-state indicator 432 includes a second plate member 442, a second protruding member 443 extending downwardly from the second plate member 442, and an indicator light-passage hole 444 vertically passing through the second plate member 442 and the second protruding member 443. The indicator light-passage hole 444 includes a second irradiating aperture 448 formed in the second protruding member 443, and which is frustoconical in shape with a downwardly increasing diameter. When the state-indicating element 436 emits light, light is projected and dispersed from the second indicating aperture 448.

The illuminating light-guiding plate 433 and the indicator light-guiding plate 435 are made of a transparent material such that light can be emitted from the light-guiding plates 433, 435 themselves, rather than through only the light-passage holes 441, 444. This enhances the illumination effect of both the illuminating unit 431 and the operating-state indicator 432.

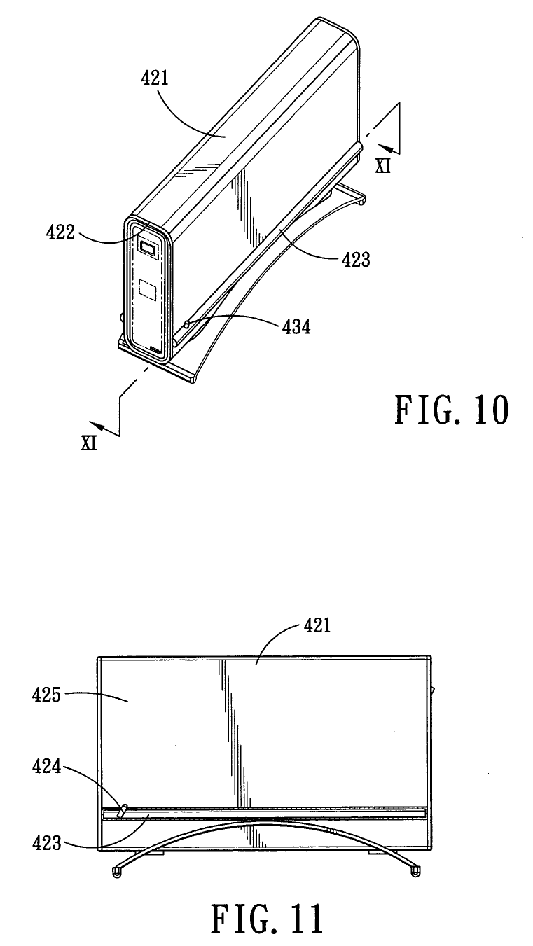

Referring to FIGS. 10 and 11, an external data storage device capable of projecting external light according to a second preferred embodiment of the present invention has an overall structure that is similar to that of the first preferred embodiment. In this embodiment, however, a rib 423 is formed on each side surface 425 of the casing 421, and a blind hole 424 is formed in each of the ribs 423 in proximity to one of the lids 422 and at a slanted angle. One of the light-emitting elements 434 is mounted in each of the blind holes 424. When the light-emitting elements 434 project light by operation of the power switch 311 (see FIG. 4), the light is symmetrically irradiated onto both of the side surfaces 425 of the casing 421 to thereby provide an attractive lighting effect.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. An external data storage device adapted to be electrically coupled to a computer device, said external data storage device comprising:
a housing unit including a control board having a coupler that is adapted for establishing electrical coupling with the computer device, and a power-managing module that is capable of being activated regardless of whether there is coupling between said external data storage device and the computer device;
a data storage unit mounted in said housing unit, and electrically coupled to said control board; and
a light-generating assembly mounted on said housing unit, and electrically coupled to and controlled by said control board of said housing unit, said light-generating assembly being operable to provide a decorative illuminating effect regardless of whether there is coupling between said external data storage device and the computer device, and being further operable to provide a status indicating effect for indicating an operating state of said data storage unit when there is coupling between said external data storage device and the computer device.

2. The external data storage device of claim 1, wherein said light-generating assembly includes:
an operating-state indicator controlled by said control board to emit light during read and write operations of said data storage unit; and
an illuminating unit controlled by said control board to provide the decorative illuminating effect.

3. The external data storage device of claim 2, wherein said operating-state indicator includes:
an indicator light-guiding plate mounted on said housing unit and formed with an indicator light-passage hole therethrough; and
a state-indicating element electrically coupled to said control board and mounted in said housing unit above said indicator light-guiding plate such that light emitted by said state-indicating element passes through said indicator light-passage hole.

4. The external data storage device of claim 2, wherein said illuminating unit includes:
an illuminating light-guiding plate mounted on said housing unit and formed with at least one illuminating light-passage hole therethrough; and
at least one light-emitting element electrically coupled to said control board and mounted in said housing unit above said illuminating light-guiding plate.

5. The external data storage device of claim 4, further comprising:
a base for supporting said housing unit on a support surface, said base including a downwardly curved arc-shaped stand defining a slot in a center portion thereof, said arc-shaped stand having two support ends contacting the support surface to support said housing unit thereon;
wherein said light-emitting element of said illuminating unit is positioned such that light emitted by said light-emitting element passes through said illuminating light-passage hole onto the support surface via said slot of said arc-shaped stand when said illuminating unit is operated by said control board.

6. The external data storage device of claim 2, wherein said power-managing module includes a user-controlled power switch, said illuminating unit being controlled by said control board to emit light upon activation of said power-managing module via user operation of said power switch.

7. The external data storage device of claim 2, wherein said housing unit includes opposing side surfaces, said illuminating unit including at least one light-emitting element mounted to one of said side surfaces.

8. The external data storage device of claim 7, further comprising at least one rib formed on one of said side surfaces of said housing unit, said rib having a blind hole formed therein, said light-emitting element being mounted in said blind hole.
